(19) United States
(12) Patent Application Publication
(10) Pub. No.: US 2026/0019942 A1
(43) Pub. Date: Jan. 15, 2026

(54) ENABLING STATIONS TO INFLUENCE ACCESS POINT POWER SAVE

(71) Applicant: Cisco Technology, Inc., San Jose, CA (US)

(72) Inventors: Binita GUPTA, San Diego, CA (US); Brian D. HART, Sunnyvale, CA (US); Vishal S. DESAI, San Jose, CA (US)

(21) Appl. No.: 19/269,879

(22) Filed: Jul. 15, 2025

Related U.S. Application Data
(60) Provisional application No. 63/671,638, filed on Jul. 15, 2024.

(51) Int. Cl. H04W 52/02

(52) U.S. Cl. CPC H04W 52/0206

(57) ABSTRACT

Techniques for optimizing power save operations between access points and associated stations. The techniques include initiating a power save mode on one or more links of an access point. The techniques further include receiving, in response to the initiating, a connectivity request at the access point from one or more stations associated with the access point requesting to connect to the access point via the one or more links. The techniques further include adjusting operations of the one or more links of the access point based on the connectivity request while in the power save mode.

### CROSS-REFERENCE TO RELATED APPLICATIONS

This application claims benefit of co-pending U.S. provisional patent application Ser. No. 63/671,638 filed Jul. 15, 2024. The aforementioned related patent application is herein incorporated by reference in its entirety.

### TECHNICAL FIELD

Embodiments presented in this disclosure generally relate to wireless communications. More specifically, embodiments disclosed herein relate to optimizing power save operations between access points and associated stations.

### BACKGROUND

Devices, such as mobile phones, tablets, laptop computers, etc., are becoming increasingly more capable, integrated with a variety of functions which may include Bluetooth, Wi-Fi, and LTE capabilities. For example, these devices may regularly connect to Wi-Fi services, such as via an access point. In some cases, the access points may be equipped with power save capabilities which enable the access points to reduce their power consumption (e.g., by shutting down the access point, shutting down a particular link of the access point, reducing power on one or more links of the access point, etc.). Such practices may result in devices associated with the access point losing connectivity or experiencing reduced performance (e.g., slower download speeds, etc.) while the access point is in a power save mode. With both personal and business transactions across the world relying heavily on steady access to wireless communication, even minor or temporary disruptions in service may cause significant ramifications. Thus, there is a need for techniques for minimizing the disruptive effects of access point power save operations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example access point (AP) and one or more connected devices with Wi-Fi capabilities, according to some embodiments of the present disclosure.

FIG. 2 illustrates an example architecture of a multi-link device (MLD), according to certain embodiments.

FIG. 3 depicts one or more example stations (STAs) reporting connectivity requests to an associated AP, according to some embodiments of the present disclosure.

FIG. 4 depicts an example AP providing an updated power save indication to a connected STA, according to some embodiments of the present disclosure.

FIG. 5 depicts an example interaction in which the associated AP receives one or more connectivity requests and provides the updated power save indication to the connected STA, according to some embodiments of the present disclosure.

FIG. 6 depicts an example method in which the associated AP evaluates the connectivity requests and adjusts operations accordingly, according to some embodiments of the present disclosure.

FIG. 7 is a flow diagram depicting an example method 700 for optimizing power save operations, according to some embodiments of the present disclosure.

FIG. 8 is an additional flow diagram depicting an example method 800 for optimizing power save operations, according to some embodiments of the present disclosure.

FIG. 9 depicts an example network device 900 configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

Embodiments described herein include a method. The method includes initiating a power save mode on one or more links of an access point. The method further includes receiving, in response to the initiating, a connectivity request at the access point from one or more stations associated with the access point requesting to connect to the access point via the one or more links. The method further includes adjusting operations of the one or more links of the access point based on the connectivity request while in the power save mode.

Embodiments further include an access point, including one or more processors and one or more memories storing a program, which, when executed on any combination of the one or more processors, performs operations. The operations include announcing a scheduled power save mode of an access point. The operations further include receiving, in response to the announcing, a connectivity request at the access point from one or more stations associated with the access point requesting to connect to the access point. The operations further include adjusting parameters of the scheduled power save mode based on the connectivity request.

Embodiments further include an additional access point, including one or more processors and one or more memories storing a program, which, when executed on any combination of the one or more processors, performs operations. The operations include initiating a power save mode on one or more links of an access point. The operations further include receiving, in response to the initiating, a connectivity request at the access point from one or more stations associated with the access point requesting to connect to the access point via the one or more links. The operations further include adjusting operations of the one or more links of the access point based on the connectivity request while in the power save mode.

### EXAMPLE EMBODIMENTS

Aspects of the present disclosure provide apparatuses, methods, processing systems, and computer-readable mediums for optimizing power save operations between APs and associated STAs.

Nowadays, APs support a number of STAs (e.g., mobile phones, tablets, laptop computers, etc.) that are connected to the APs for wireless services, such as Wi Fi. Increasingly, the APs are equipped with power save capabilities which allow the APs to wholly or partially shut down operations to conserve power (e.g., during downtime hours, to meet power usage limitations, etc.). Operating in a power save mode, especially for extended periods of time, however, may result in STAs losing connectivity or STAs left with reduced performance (e.g., slower download speeds, etc.), which can have substantial impacts.

To optimize power save operations between APs and associated STAs, techniques described herein evaluate, at an AP, a number of connectivity requests received from connected STAs and, based on the evaluating, adjust power save operations at the AP. As such, the AP is able to balance competing interests of beneficial power savings with enhanced wireless connectivity by determining the optimal level of power save operations while taking into account the performance of connected STAs.

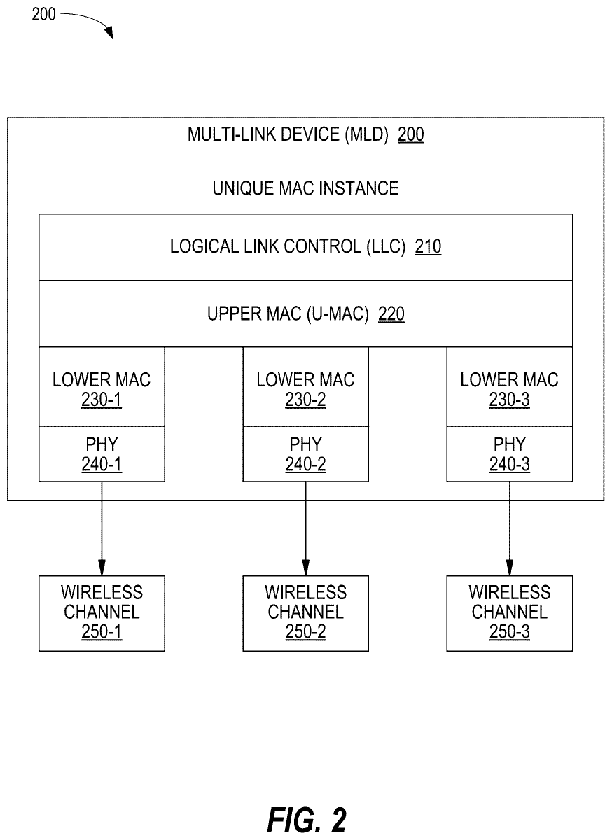

For example, an AP first initiates a power save mode. The AP may be a single AP or an AP multi-link device (AP MLD). An AP MLD may include multiple links, or support multiple frequency bands (e.g., 2.4 GHz, 5 GHZ, and 6 GHZ), to which STAs, or devices, may connect for wireless service, as depicted below with respect to FIG. 2. In some embodiments, the power save mode includes shutting down a subset of the links of the AP/AP MLD. In other embodiments, the power save mode includes the AP/AP MLD (or links thereof) remaining operational (i.e., not shutting down), but at a lower capacity (e.g., reduced power with lessened functionality) than during a fully active mode. Initiating the power save mode may include beginning to operate in the power save mode or sending an announcement to the STAs informing them of an upcoming power save mode (e.g., prior to entering the power save mode).

The AP then receives, in response to initiating the power save mode, a connectivity request from one or more STAs associated with the AP (e.g., connected STAs receiving wireless service from the AP). The connectivity request notifies the AP that a particular STA would like the AP to provide service, wake up from a power save mode, or the like. The connectivity request may also include an indication of a particular link, or links, of the AP to which the STA prefers to connect, such as when the AP is an AP MLD with multiple links. The AP then evaluates the connectivity requests to determine whether it will adjust its operations in response. In some cases, the AP may send a response to the STAs informing them of whether the AP will consider the request. In other cases, the AP may automatically adjust operations if the number of connectivity requests exceeds a threshold number.

Based on the connectivity requests, the AP may then adjust its operations. The AP may also disregard the connectivity requests and remain operating in the power save mode. If the AP decides to adjust its operations, the AP may terminate the power save mode, change to a different power save mode, cancel an upcoming power save mode, or the like. In one example, the AP may also send, via a management frame, an updated power save indication to the STAs with information (e.g., an updated power save state, an updated power save schedule, updated power save capabilities, etc.) about the new power save mode (or that the power save mode is terminated).

These techniques ensure improved wireless connectivity for STAs, as the STAs can request that the AP alter or cease power save operations for better performance, while the AP can retain power saving functionality (the AP may select if or when it adjusts operations).

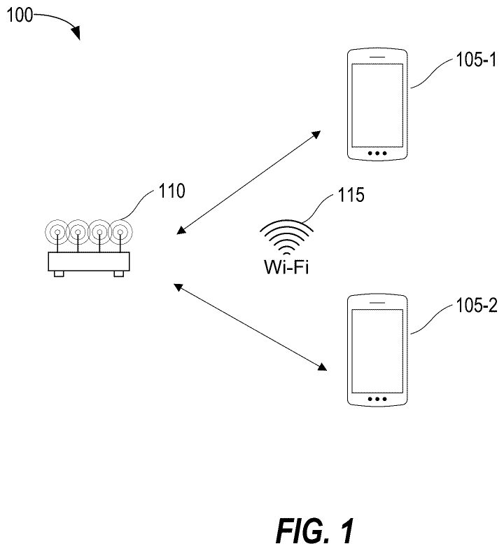

FIG. 1 depicts an example AP and one or more connected devices with Wi-Fi capabilities, according to some embodiments of the present disclosure.

As depicted, STA 105-1 and/or STA 105-2 connects to AP 110 as a client in a basic service set (BSS). Through this wireless connection 115 (e.g., a Wi-Fi connection), STAs 105-1 and 105-2 gain access to the broader network infrastructure (e.g., Internet). This connection 115 follows a Wi-Fi infrastructure mode, where AP 110 manages the communication between STAs and other devices on the network and coordinates transmission timing and resource allocation.

In this figure, STAs 105-1 and 105-2 are depicted as mobile phones, which is provided for conceptual clarity. In some embodiments, STAs 105-1 and 105-2 may be any other wireless communication devices, such as laptops, tablets, smartwatches, any other portable or stationary devices configured with wireless communication technologies, or a combination thereof. In certain embodiments, there may be additional devices or fewer devices connected to AP 110 than depicted in this figure.

The depicted wireless technologies, including Wi-Fi for infrastructure connections 115, are provided as examples for conceptual clarity. In some embodiments, STAs 105-1 and/or 105-2 may support additional wireless communication interfaces, including Bluetooth (used for low-power, short-range data exchange, such as audio streaming, peripheral device pairing, or file transfers), Ultra-Wideband (used for high-precision spatial awareness and data synchronization, such as indoor positioning, secure keyless access, or high-speed data transfer between devices), Wi-Fi Direct (used for high-speed and medium-range data transfer, such as sharing large files or streaming high-quality media between devices), Wi-Fi for off-channel docking (used for wireless display mirroring, data transfer, or peripheral connections to a docking station) or Near Field Communication (NFC) (for short-range authentication and data exchange).

In some embodiments, STAs 105-1 and/or 105-2 may utilize a multi-link operation (MLO) setup, where the devices maintain simultaneous connections to AP 110 over multiple frequency bands. For example, STA 105-1 may simultaneously establish three concurrent links with AP 110, including one link on the 2.4 GHz band (for longer range and lower power consumption), one link on the 5 GHz band (for higher throughput and reduced interference), and one link on 6 GHz band (for ultra-fast and low-latency communication).

In order to enable power save operations at the AP 110 while also maintaining steady connectivity between the AP 110 and STAs 105-1 and 105-2, the AP 110 may evaluate connectivity requests received from STAs 105-1 and 105-2 and, in response, adjust operations at the AP 110. Further details about evaluating the connectivity requests and adjusting power save operations are discussed below.

FIG. 2 illustrates an example architecture of a MLD 200, according to certain embodiments. The MLD 200 may be an AP MLD or a STA MLD. As depicted in FIG. 2, the MLD 200 provides a unique MAC instance to multiple wireless interfaces (e.g., wireless channels 250 1-N), each of which may be utilized by a respective “radio” (e.g., AP 110 or STA 105-1). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250 (e.g., link).

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link. As used herein, the term “radio” may refer to the capability to connect to a peer device on a link and may include multiple physical radios and/or multiple logical radios enabled by a single physical radio.

According to some embodiments, the MLD 200 may include an AP MLD providing wireless service via one or more of the wireless channels 250 to one or more connected STAs. The AP MLD may adjust operations as well as generate and transmit an updated power save mode indication to the connected STAs on one or more of the channels 250, as described in more detail below.

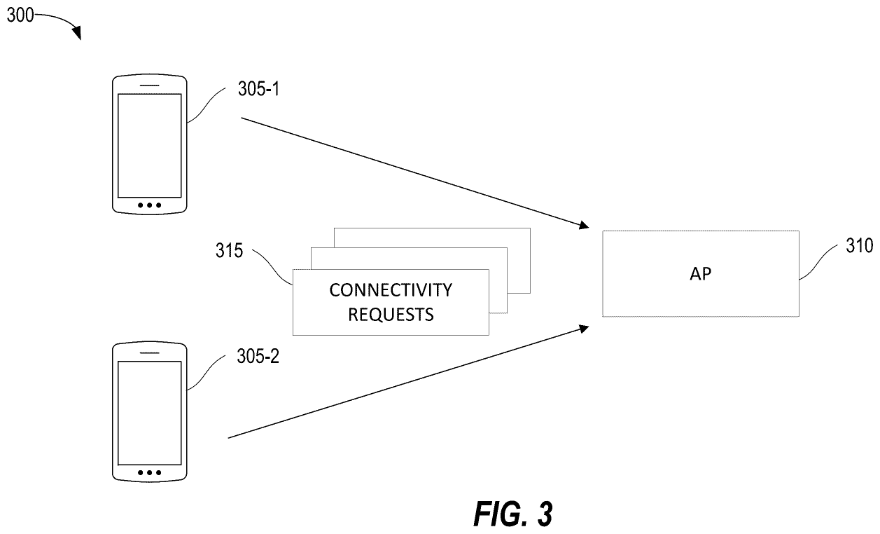

FIG. 3 depicts one or more example STAs reporting connectivity requests to an associated AP, according to some embodiments of the present disclosure.

As depicted, AP 310 (which may correspond to AP 110 of FIG. 1 or an AP MLD corresponding to MLD 200 of FIG. 2) receives connectivity requests 315 from one or more connected STAs 305-1 and 305-2 (which may correspond to STA 105-1 and STA 105-2 of FIG. 1). The connectivity requests 315 indicate to the AP 310 that the STAs 305-1 and 305-2 are seeking to connect to the AP 310 (or a particular link thereof) or that the STAs 305-1 and 305-2 want the AP 310 to wake up (i.e., end the power save mode and return to full power). In cases where AP 310 is an AP MLD with multiple links, the connectivity requests 315 may contain an indication of one or more preferred links of the AP 310 (i.e., identified by the STAs 305-1 and 305-2) that are operating in the power save mode (or that the AP 310 has announced will be entering a power save mode).

STAs 305-1 and 305-2 may send the connectivity requests 315, for example, via a stream classification service (SCS) request, where the preferred link(s) among the links in power save are indicated in an optional sub-element. Alternatively, STAs 305-1 and 305-2 may use a new action frame to indicate the preferred link(s). Additionally, a new information element may indicate a set of <link ID, desired power save state, power save capability desired> for one or more links operating in or entering the power save mode. In other embodiments, STAs 305-1 and 305-2 send the connectivity requests 315 (e.g., indicating the preferred link) in-band in data frames using A-Control while operating on another link of the same AP MLD. For example, a STA (such as STA 305-1) operating on a 5 GHz link of AP 310 can signal in A-Control the link ID for the 6 GHz link as the preferred link. To accomplish this, a new A-Control field can be defined or a preferred link ID field (comprising 4 bits) can be added to another existing A-Control field (e.g., operating mode indication).

Upon receiving the connectivity requests from STAs 305-1 and 305-2, AP 310 may then determine whether to adjust its operations along with what adjustments it will make (e.g., alter the power save mode, terminate the power save mode, etc.), as discussed in more detail below.

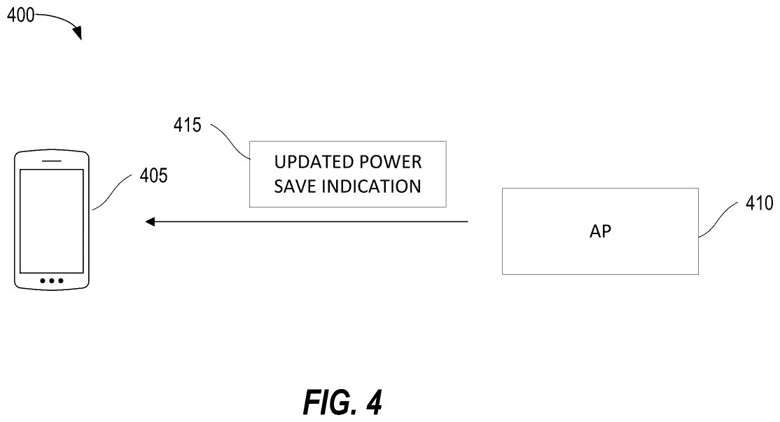

FIG. 4 depicts an example AP providing an updated power save indication to a connected STA, according to some embodiments of the present disclosure.

As depicted, AP 410 (which may correspond to AP 110 of FIG. 1, AP 310 of FIG. 310, or an AP MLD corresponding to MLD 200 of FIG. 2) sends an updated power save indication 415 to STA 405 (which may correspond to STA 105-1 and/or STA 105-2 of FIG. 1 or STA 305 of FIG. 3). The updated power save indication 415 provides STA 405 with information associated with the new power save mode of AP 410 (i.e., in cases where the AP 410 elects to adjust its operations). For example, the updated power save indication 415 may contain an updated power save state associated with the power save mode and an updated schedule of the power save mode, as well as updated power save capability information. For example, power save states may include a full doze state (i.e., where the AP is shut down for the duration of the power save mode), a doze state with wake up functionality (i.e., the AP is shut down but may return to active mode when certain traffic is detected), a static low capability state (i.e., the AP operates at a lower power level with reduced capability for the duration of the power save mode), a dynamic power state (i.e., an AP MLD can switch between multiple links and power save states such as via eMLSR), and/or a compatibility support listen state (i.e., the AP operates in power save mode for some STAs, such as ultra-high reliability (UHR) devices, but remains active for other devices), among others. The schedule of the power save mode may include information describing a start time for the power save mode, a duration for the power save mode, and/or the like, so that the STA 405 will know when to expect the AP 410 (or a link thereof) to be disabled, operating at a reduced capacity, etc. Power save capability information may include the number of spatial streams, bandwidth, modulation coding scheme, and/or the like that are supported during the power save mode.

In some cases, such as when the AP 410 terminates the power save mode altogether, the updated power save indication 415 may inform the STA 405 that the AP 410 (or certain links thereof) is returning to a fully active, or awake, mode. The AP 410 may send the updated power save indication 415 to the STA 405 via a management frame, such as a beacon response frame or a probe response frame, among others.

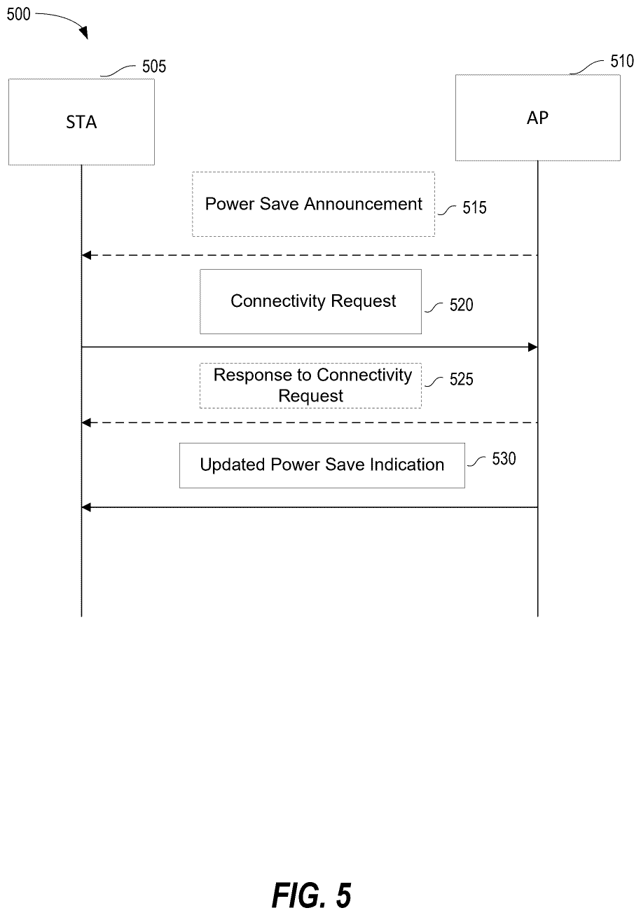

FIG. 5 depicts an example interaction in which the associated AP receives one or more connectivity requests and provides the updated power save indication to the connected STA, according to some embodiments of the present disclosure.

As depicted, AP 510 may send a power save announcement 515 to STA 505 (e.g., via a beacon response frame, probe response frame, or the like), which may be associated with AP 510 (i.e., connected to AP 510 for receiving wireless service). The power save announcement 515 may include an indication of the links entering a power save mode (e.g., in cases where the AP includes an AP MLD with multiple links), along with additional information associated with the power save mode, such as the power save state, power save schedule, and the like. In some embodiments, the AP 510 begins the power save mode without sending a power save announcement 515 to STA 505.

In response to receiving the power save announcement 515, or in response to AP 510 entering the power save mode, STA 505 sends a connectivity request 520 to AP 510. The connectivity request 520 informs the AP 510 that the STA 505 would like the AP 510 (or a link thereof) to wake up from the power save mode (or not enter a scheduled power save mode) so that the STA 505 may receive full wireless connectivity. The connectivity request 520 may contain, in cases where the AP 510 is an AP MLD with multiple links, an indication of one or more preferred links of the AP 510 that the STA 505 wishes to wake up. As discussed above with respect to FIG. 3, the connectivity request 520 may be sent via an SCS request, a new action frame, or a new information element, among others. In other embodiments, A-Control signaling may be used for indicating the preferred links.

Once the AP 510 receives the connectivity request 520, the AP 510 may send a response to connectivity request 525 back to the STA 505. The response to connectivity request 525 may indicate whether the AP 510 accepts or rejects the connectivity request 520. For example, a response accepting the connectivity request 520 may indicate that the AP 510 will consider the request when evaluating whether to alter its power save operations (but accepting the request does not require the AP 510 to alter its power save operations).

Lastly, upon determining to alter its power save operations, the AP 510 sends an updated power save indication 530 to the STA 505. The updated power save indication 530 provides STA 505 with information associated with the new power save mode of AP 510. For example, the updated power save indication 530 may contain an updated power save state associated with the power save mode (e.g., doze state, static low capability, dynamic, etc.) and an updated schedule of the power save mode (e.g., a start time, duration, etc.), as well as updated power save capability information. The updated power save indication 530 may be sent from the AP 510 to the STA 505 using a management frame, such as a beacon response frame or a probe response frame, among others. In some embodiments, the AP 510 may not send an updated power save indication, such as when the AP 510 decides not to alter its power save operations (i.e., chooses to remain operating via the current power save mode). If the AP 510 decides to terminate the power save mode entirely, it may send a corresponding notification in lieu of the updated power save indication 530, or nothing at all.

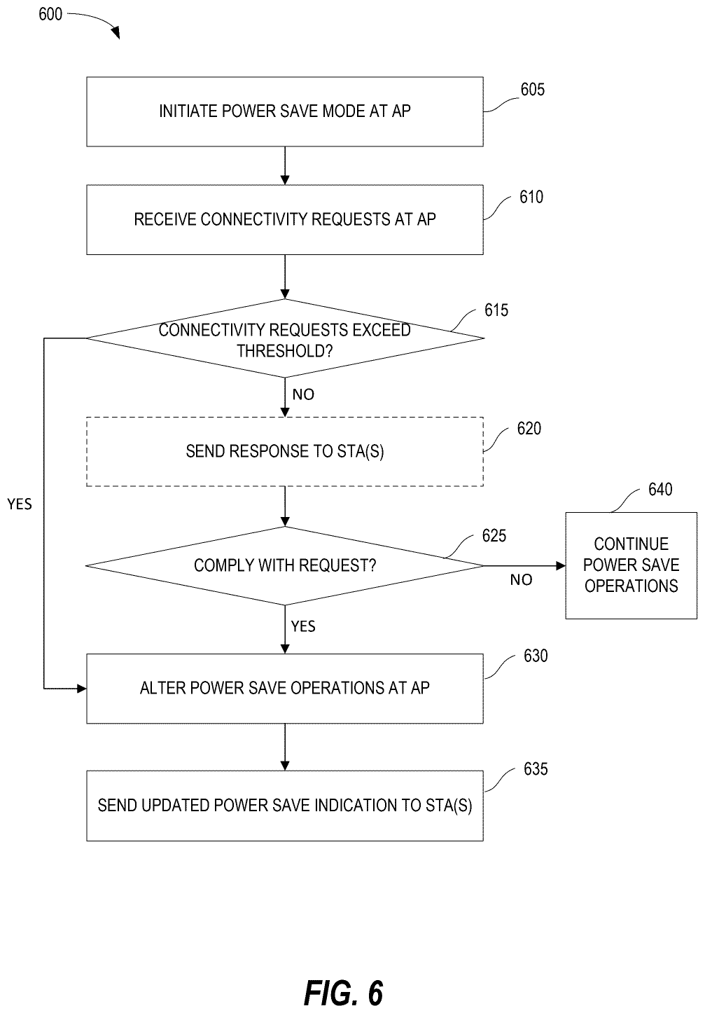

FIG. 6 depicts an example method in which the associated AP evaluates the connectivity requests and adjusts operations accordingly, according to some embodiments of the present disclosure. In some embodiments, the method 600 may be performed by one or more network devices, such as AP 110 as depicted in FIG. 1, AP 310 as depicted in FIG. 3, and AP 410 as depicted in FIG. 4.

At block 605, an AP (e.g., AP 110 of FIG. 1, AP 310 of FIG. 3, or AP 410 of FIG. 4), initiates a power save mode. To initiate the power save mode, the AP begins power save operations or, in some cases, the AP provides an announcement (e.g., power save announcement 515 of FIG. 5) to one or more STAs associated with the AP prior to entering the power save mode. In some embodiments, the AP may be an AP MLD comprising multiple links. The entire AP/AP MLD may be entering power save mode or only a subset of the links may be entering the power save mode. The power save mode may involve shutting down a portion (e.g., certain links) of the AP completely or reducing the capabilities of the AP, or links thereof (e.g., limiting certain functions, operating at a lower power, and/or the like).

At block 610, the AP receives connectivity requests (e.g., connectivity requests 315 of FIG. 3) from one or more connected STAs (e.g., STAs 105-1 and/or 105-2 of FIG. 1, STAs 305-1 and/or 305-2 of FIG. 3, or STA 405 of FIG. 4). The connectivity requests inform the AP that the connected STAs would like the AP (or a link thereof) to wake up from the power save mode (or cancel a scheduled power save mode in cases where it has not yet begun). For example, in cases where the AP is an AP MLD with multiple links, the connectivity requests contain an indication of one or more preferred links of the AP that the connected STA wishes to wake up. The connectivity requests may be sent from the connected STAs to the AP via management frame signaling (e.g., using an SCS request, a new action frame, or a new information element, or the like) or via A-Control signaling.

At block 615, the AP determines whether the number of connectivity requests received from the connected STAs exceeds a threshold value. If the number of connectivity requests exceeds the threshold value (i.e., indicating that a significant number of STAs find it important to connect to a particular link in fully awake mode), the method continues to block 630 where the AP adjusts its operations accordingly without any further evaluation of the connectivity requests. If the number of connectivity requests does not exceed the threshold value, the method proceeds to block 620.

At block 620, the AP may send a response to the connectivity request from each STA. The response may indicate whether the AP accepts or rejects the particular connectivity request. For example, a response accepting a connectivity request may indicate that the AP will take into account the corresponding STA's preferences when evaluating whether to alter its power save operations. Accepting the request, however, does not require the AP to alter its power save operations; it only notifies the STA that the AP has received and will consider the request. In another example, the AP may send a response rejecting the connectivity request from the STA (e.g., the AP will disregard the request). In some embodiments, the AP may not send a response, and the method proceeds directly to block 625.

At block 625, the AP determines whether it will adjust its operations in response to the connectivity request. The AP may consider, among others, how many similar requests were received, the type of power save mode at which it is operating, how long it has been operating in the power save mode, power save goals or requirements, how many times it has woken up previously, and the like. In one embodiment, the AP is not required to comply with the connectivity requests, but has the option to do so. In this way, the AP balances providing optimal wireless connectivity for the connected STAs while retaining control so that it is not constantly forced to cycle in between modes or stay permanently awake (i.e., effectively eliminating any power save gains). If the AP chooses to adjust its operations, the method proceeds to block 630. If the AP chooses to not adjust its operations, the AP will continue its current power save operations, as depicted at block 640.

At block 630, the AP adjusts its operations to comply with one or more of the connectivity requests. For example, the AP may terminate the power save mode of the AP (or on one or more links of the AP) and begin operating in a fully awake mode. In another example, the AP may remain in power save mode, but switch to a different save state (e.g., from a doze state where a link was completely shut down to a static low capability state where the link is operating but at reduced power), which may still offer connected STAs service while maintaining some power save operations. In cases where the AP sent an announcement prior to a scheduled power save mode, adjusting operations may include canceling the upcoming power save mode.

At block 635, the AP sends an updated power save indication to the connected STAs. The updated power save indication provides the connected STAs with information about the new power save mode of the AP. For example, the updated power save indication may contain an updated power save state (e.g., doze state, static low capability, dynamic, etc.), an updated power save schedule (e.g., a start time, duration, etc.), and/or updated power save capability information (number of spatial streams, bandwidth, etc.). The AP may send the updated power save indication via a management frame, such as a beacon response frame, a probe response frame, or the like. In some embodiments, the updated power save indication notifies the connected STAs that the AP is terminating the power save mode and returning to a fully active mode.

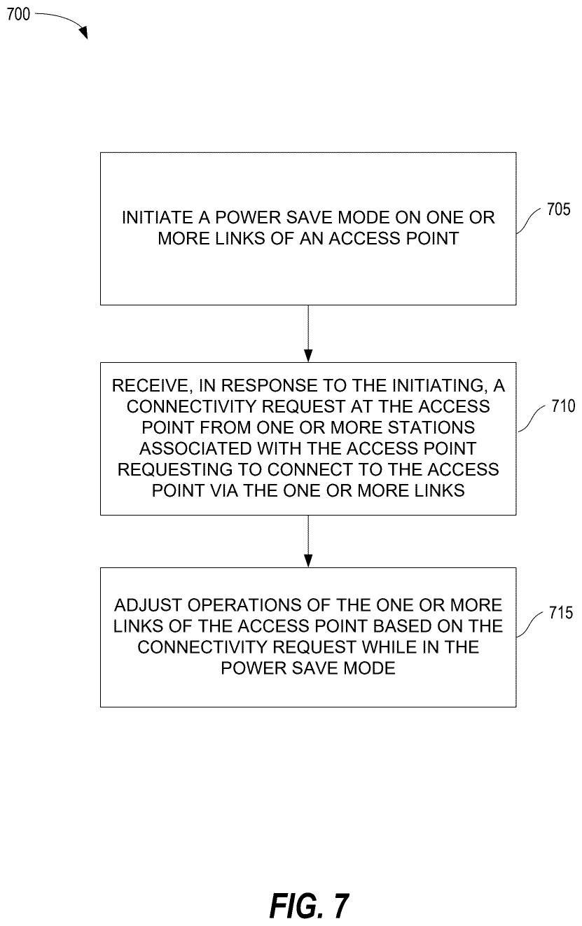

FIG. 7 is a flow diagram depicting an example method 700 for optimizing power save operations, according to some embodiments of the present disclosure.

At block 705, an AP (e.g., AP 110 of FIG. 1, AP 310 of FIG. 3, or AP 410 of FIG. 4) initiates a power save mode. As discussed at block 605 of FIG. 6, the power save mode may include shutting down operations, reducing capability, and/or the like. Initiating the power save mode may include the AP beginning power save operations and, in some cases, may include the AP providing an announcement to one or more STAs associated with the AP prior to entering the power save mode. In some embodiments, the AP is an AP MLD with multiple links where some or all of the links are entering the power save mode.

At block 710, the AP receives, in response to the initiating, a connectivity request from one or more STAs associated with the AP (e.g., STAs 105-1 and 105-2 of FIG. 1, STA 305 of FIG. 3, or STA 405 of FIG. 4), as discussed at block 610 of FIG. 6. Via the connectivity requests, the STAs may request to connect to the AP. For example, the connectivity requests may contain an indication of one or more preferred links of the AP (i.e., links to which the STAs wish to connect for wireless services), wherein the one or more preferred links are operating in the power save mode (e.g., at the time the connectivity requests are received).

At block 715, the AP, while in power save mode, adjusts operations based on the connectivity request. Adjusting operations may include terminating the power save mode of a particular link of the AP, updating the power save mode of a particular link of the AP, disregarding the connectivity request, sending a response to one of the STAs associated with the AP, or a combination thereof. For example, if the AP accepts the connectivity request from one of the STAs, the AP may return to fully active operations. Accepting the connectivity request, however, is optional; the AP may remain operating in the power save mode after receiving the connectivity requests.

In some embodiments, the AP may provide, to the one or more STAs associated with the AP, an updated power save mode indication based on the adjusted operations of the access point. For example, as discussed at block 635 of FIG. 6, the updated power save mode indication includes an updated power save state (e.g., doze state, static low capability, dynamic, etc.), an updated power save schedule (e.g., a start time, duration, etc.), and/or updated power save capability information (e.g., number of spatial streams, bandwidth, etc.). In some other embodiments, the AP may terminate the power save mode of a particular link of the AP (or the entire AP) if the AP receives more than a threshold number of connectivity requests requesting to connect to the AP via that particular link (e.g., a high number of connectivity requests signals to the AP that wireless service is important to the STAs and that the AP should return to awake mode).

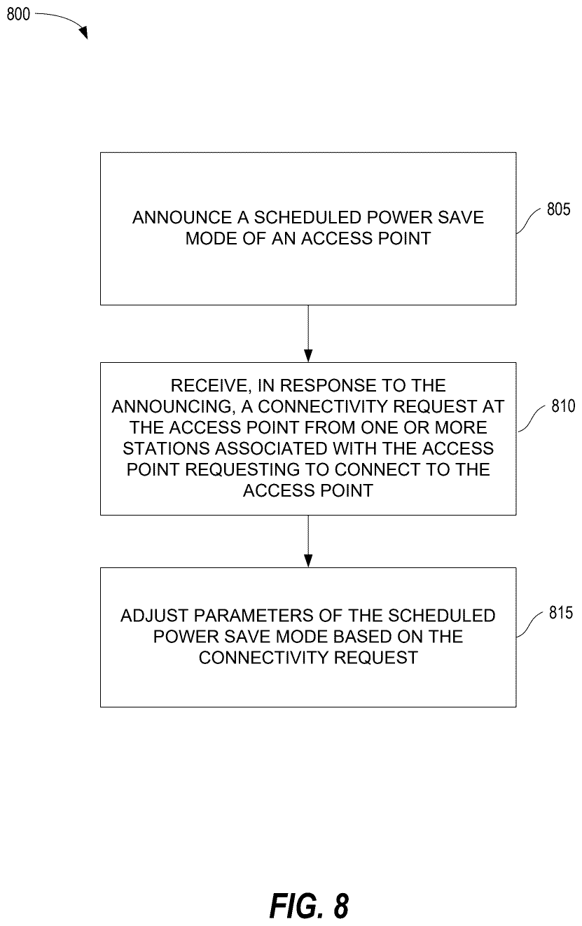

FIG. 8 is an additional flow diagram depicting an example method 800 for optimizing power save operations, according to some embodiments of the present disclosure.

At block 805, an AP (e.g., AP 110 of FIG. 1, AP 310 of FIG. 3, or AP 410 of FIG. 4) announces (e.g., to connected STAs) a scheduled power save mode. As discussed at block 605 of FIG. 6, the power save mode may include shutting down operations, reducing capability, and/or the like. In some embodiments, the AP is an AP MLD with multiple links where some or all of the links are entering the power save mode.

At block 810, the AP receives, in response to the announcing, a connectivity request from one or more STAs associated with the AP (e.g., STAs 105-1 and 105-2 of FIG. 1, STA 305 of FIG. 3, or STA 405 of FIG. 4), as discussed at block 610 of FIG. 6. Via the connectivity requests, the STAs may request to connect to the AP. For example, the connectivity requests may contain an indication of one or more preferred links of the AP (i.e., links to which the STAs wish to connect for wireless services), wherein the one or more preferred links are scheduled to begin power save operations.

At block 815, the AP, prior to initiating the scheduled power save mode, adjusts parameters of the scheduled power save mode based on the connectivity request. Adjusting operations may include terminating the scheduled power save mode of a particular link of the AP (i.e., the AP remains in its current, awake mode), updating the power save mode of a particular link of the AP (e.g., changing certain features of the power save mode before initiating it), disregarding the connectivity request, sending a response to one of the STAs associated with the AP, or a combination thereof. For example, if the AP accepts the connectivity request from one of the STAs, the AP may remain in fully active operations. Accepting the connectivity request, however, is optional; the AP may still begin operating in the scheduled power save mode after receiving the connectivity requests.

In some embodiments, the AP may provide, to the one or more STAs associated with the AP, an updated power save mode indication based on the adjusted parameters of the scheduled power save mode. For example, as discussed at block 635 of FIG. 6, the updated power save mode indication includes an updated power save state (e.g., doze state, static low capability, dynamic, etc.), an updated power save schedule (e.g., a start time, duration, etc.), and/or updated power save capability information (e.g., number of spatial streams, bandwidth, etc.). In some other embodiments, the AP may terminate the scheduled power save mode of a particular link of the AP (or the entire AP) if the AP receives more than a threshold number of connectivity requests requesting to connect to the AP via that particular link (e.g., a high number of connectivity requests signals to the AP that wireless service is important to the STAs and that the AP should remain in awake mode).

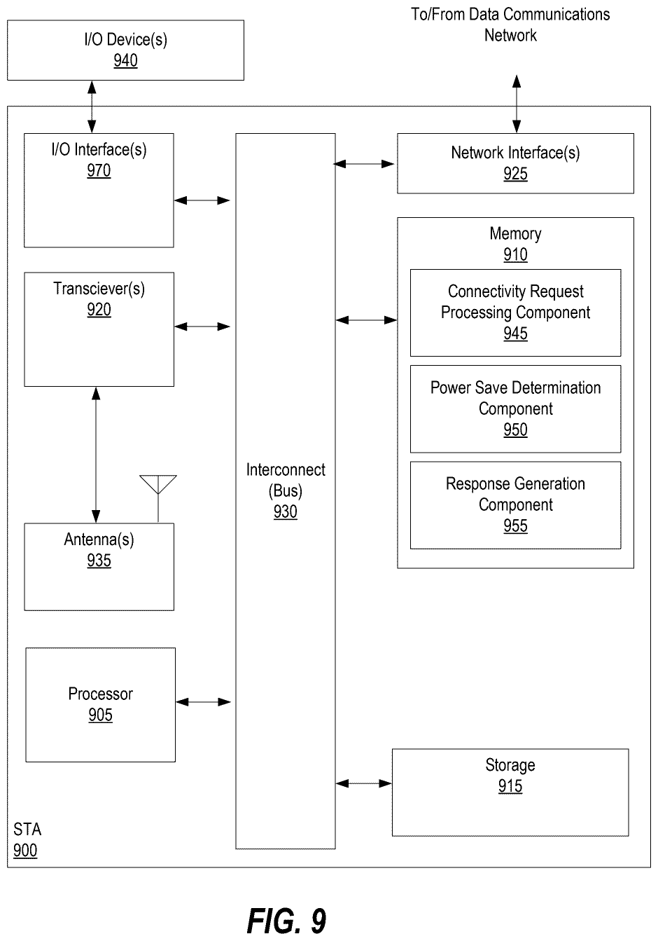

FIG. 9 depicts an example network device 900 configured to perform various aspects of the present disclosure. In some embodiments, the example network device 900 may be an AP or a STA, and communicate with and/or provide support for an associated STA (e.g., which is a device that operates multiple wireless technologies on shared hardware).

As illustrated, the example network device 900 includes a processor 905, memory 910, storage 915, one or more transceivers 920, one or more I/O interfaces 970, and one or more network interfaces 925. In some embodiments, I/O devices 940 are connected via the I/O interface(s) 970. Further, via the network interface 925, the network device 900 can be communicatively coupled with one or more other devices and components (e.g., via a network, which may include the Internet, local network(s), and the like). Each of the components is communicatively coupled by one or more buses 930. In some embodiments, one or more antennas 935 may be coupled to the transceivers 920 for transmitting and receiving wireless signals.

The processor 905 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 905 processes information received through the transceiver 920, I/O interfaces 970, and the network interfaces 925. The processor 905 retrieves and executes programming instructions stored in memory 910, as well as stores and retrieves application data residing in storage 915.

The storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 915 may store a variety of data for the efficient functioning of the system.

The memory 910 may include random access memory (RAM) and read-only memory (ROM). The memory 910 may store processor-executable software code containing instructions that, when executed by the processor 905, enable the network device 900 to perform various functions described herein for wireless communication. In the illustrated example, the memory 910 includes three software components: the connectivity request processing component 945, the power save determination component 950, and the response generation component 955.

In one embodiment, the connectivity request processing component 945 may evaluate connectivity requests received from associated STAs. In some embodiments, the connectivity request processing component 945 may also determine whether to accept the connectivity requests and/or store a count of the connectivity requests (e.g., for comparing to a threshold value).

In one embodiment, the power save determination component 950 may determine and implement adjustments to the AP's power save operations, such as selecting a type of power save mode, initiating the power save mode, determining the duration of the power save mode, and/or the like.

In one embodiment, the response generation component 955 may generate an updated power save indication (e.g., containing updated power save state, schedule, and capability information) in response to the connectivity requests and may send the updated power save indication to the connected STAs.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 910, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
initiating a power save mode on one or more links of an access point;
receiving, in response to the initiating, a connectivity request at the access point from one or more stations associated with the access point requesting to connect to the access point via the one or more links; and
adjusting operations of the one or more links of the access point based on the connectivity request while in the power save mode.

2. The method of claim 1, wherein the connectivity request comprises an indication of one or more preferred links of the access point, wherein the one or more preferred links are operating in the power save mode.

3. The method of claim 1, wherein the adjusting the operations of the one or more links of the access point based on the connectivity request comprises one or more of:
terminating the power save mode of a link of the one or more links;
updating the power save mode of a link of the one or more links;
disregarding the connectivity request; or
sending a response to a station of the one or more stations associated with the access point.

4. The method of claim 1, further comprising providing, to the one or more stations associated with the access point, an updated power save mode indication based on the adjusting of the operations of the access point.

5. The method of claim 4, wherein the updated power save mode indication comprises one or more of:
an updated power save schedule;
an updated power save state; or
an updated power save capability.

6. The method of claim 1, further comprising terminating the power save mode of a particular link if the access point receives more than a threshold number of connectivity requests requesting to connect to the access point via the particular link.

7. An access point, comprising:
one or more processors; and
one or more memories storing a program, which, when executed on any combination of the one or more processors, performs operations, the operations comprising:
announcing a scheduled power save mode of the access point;
receiving, in response to the announcing, a connectivity request at the access point from one or more stations associated with the access point requesting to connect to the access point; and
adjusting parameters of the scheduled power save mode based on the connectivity request.

8. The access point of claim 7, wherein the announcing the scheduled power save mode of the access point comprises providing, to the one or more stations associated with the access point, an announcement containing information associated with the scheduled power save mode, wherein the announcement is provided via a management frame.

9. The access point of claim 7, wherein the connectivity request comprises an indication of one or more preferred links of the access point, wherein the one or more preferred links are included in the scheduled power save mode.

10. The access point of claim 7, wherein the adjusting the parameters of the scheduled power save mode based on the connectivity request comprises one or more of:
terminating the scheduled power save mode of a link of the one or more links;
updating the scheduled power save mode of a link of the one or more links;
disregarding the connectivity request; or
sending a response to a station of the one or more stations associated with the access point.

11. The access point of claim 7, wherein the adjusting the parameters of the scheduled power save mode based on the connectivity request is performed prior to initiating the scheduled power save mode.

12. The access point of claim 7, further comprising providing, to the one or more stations associated with the access point, an updated power save mode indication based on the adjusting of the parameters of the scheduled power save mode.

13. The access point of claim 12, wherein the updated power save mode indication comprises one or more of:
an updated power save schedule;
an updated power save state; or
an updated power save capability.

14. The access point of claim 7, further comprising terminating the scheduled power save mode of a particular link if the access point receives more than a threshold number of connectivity requests requesting to connect to the access point via the particular link.

15. An access point, comprising:
one or more processors; and
one or more memories storing a program, which, when executed on any combination of the one or more processors, performs operations, the operations comprising:
initiating a power save mode on one or more links of the access point;
receiving, in response to the initiating, a connectivity request at the access point from one or more stations associated with the access point requesting to connect to the access point via the one or more links; and
adjusting operations of the one or more links of the access point based on the connectivity request while in the power save mode.

16. The access point of claim 15, wherein the connectivity request comprises an indication of one or more preferred links of the access point, wherein the one or more preferred links are operating in the power save mode.

17. The access point of claim 15, wherein the adjusting the operations of the one or more links of the access point based on the connectivity request comprises one or more of:
terminating the power save mode of a link of the one or more links;
updating the power save mode of a link of the one or more links;
disregarding the connectivity request; or
sending a response to a station of the one or more stations associated with the access point.

18. The access point of claim 15, further comprising providing, to the one or more stations associated with the access point, an updated power save mode indication based on the adjusting of the operations of the access point.

19. The access point of claim 18, wherein the updated power save mode indication comprises one or more of:
an updated power save schedule;
an updated power save state; or
an updated power save capability.

20. The access point of claim 15, further comprising terminating the power save mode of a particular link if the access point receives more than a threshold number of connectivity requests requesting to connect to the access point via the particular link.
